(19) United States
(12) Patent Application Publication
(10) Pub. No.: US 2010/0020530 A1
(43) Pub. Date: Jan. 28, 2010

(54) Safety marker indicator device and manufacturing methods

(76) Inventor: Ronald J. Kay, Barrington, IL (US)

Correspondence Address: VALAUSKAS & PINE LLC, Suite 620, 150 South Wacker Drive, Chicago, IL, 60606, US

(21) Appl. No.: 12/383,165

(22) Filed: Mar. 20, 2009

Related U.S. Application Data
(63) Continuation-in-part of application No. 12/220,537, filed on Jul. 25, 2008, now abandoned.

(51) Int. Cl. F21V 9/16

(52) U.S. Cl. 362/84

(57) ABSTRACT

The present invention relates generally to a safety device and more particularly to a safety marker indicator device for architectural structures, specifically a door marker indicator device for doors or door components, and improved manufacturing thereof. The improved door marker indicator device includes a photoluminescent light emission element and is manufactured by extrusion, co-extrusion, injection molding, or two-shot molding. The present invention allows door marker indicator devices to be quickly and easily installed on doors and door components.

This application is a continuation in part of application Ser. No. 12/220,537, filed on Jul. 25, 2008.

### FIELD OF THE INVENTION

The present invention relates generally to a safety device and more particularly to a safety marker indicator device for architectural structures, specifically a door marker indicator device for doors or door components, and improved manufacturing thereof.

### BACKGROUND OF THE INVENTION

Safety devices are used on architectural structures in a variety of environments to reduce risk. Many environments exist where various poor lighting scenarios occur, for example, dimmed lighting or darkness due to a power failure or smoke resultant from a fire. Risks may occur when people attempt to navigate in poorly lit environments; such risks include physical injury, lack of orientation, lack of information regarding navigation and lack of familiarity with the environment.

To mitigate these risks, illuminated safety devices exist that are typically installed on doors or door components as a visual reference. But, these prior art devices are deficient in several respects including limitations in design and manufacturability. For example, U.S. Pat. No. 4,914,554 and U.S. Pat. No. 4,981,314 are keyhole indicators that illuminate a keyhole. These designs are complex and expensive to manufacture.

U.S. Pat. No. 5,008,551 is a luminescent cover that includes a hinge for placing the cover on and removing the cover from door knobs. This cover is cumbersome to attach, and may slip when trying to turn the knob. Additionally, this design is expensive to manufacture due to its material requirements.

Although U.S. Pat. No. 6,461,012 includes a doorknob locator ring, the locator ring requires fabrication from phosphorescent plastic. A drawback of phosphorescent materials is that they do not immediately re-emit the radiation absorbed. Thus, the absorbed radiation is often re-emitted at low or no intensity creating risk that the locator ring fails to properly function. Additionally, this prior art device is made to be suspended on a door knob such that it is “free hanging”. Without being affixed to the door, the locator ring risks being lost, stolen, or inadvertently removed from the door knob.

While the prior art devices fulfill their respective particular objectives and requirements, the need still remains for an improved safety marker indicator device and manufacturing methods thereof that fulfill the deficiencies of these devices. The present invention satisfies this need.

### SUMMARY OF THE INVENTION

The improved safety marker indicator device and methods of the present invention fulfill the deficiencies in design and manufacturability of prior art devices. The present invention includes improved material compositions and material requirements. Embodiments according to the present invention contemplate one-step or two-step manufacturing processes.

The present invention is discussed herein as a door marker indicator device with respect to architectural structures that are doors or door components, and more specifically to door handles, although any architectural structure is contemplated. Door handles are anything grasped by the hand to operate the architectural structure and includes, for example, knobs, levers, sliders and push-bars.

In one embodiment, the safety marker indicator device according to the present invention includes a base element including a photoluminescent light emission element. In other embodiments, the base element includes a substrate element and a photoluminescent light emission element. Additional embodiments contemplate that the door handle itself is the base element such that the door handle is manufactured to include a photoluminescent light emission element, for example, the knob, lever, slider or push-bar is manufactured of a photoluminescent material.

The safety marker indicator device includes a base element with a front surface, back surface, as well as an outer edge and inner edge. In certain embodiments the inner edge forms a center aperture to quickly and easily position the safety marker indicator device over a door handle. The outer edge and inner edge form a device that is between about ¾ inch to about 2 inches. It is further contemplated that the base element can be any shape such as triangle, square, rectangle, oval, circle, or polygon, as well as any partial shape, to name a few. Additionally, it is contemplated that the base element includes a fracture in order to deform the device to secure it to the architectural structure.

Some embodiments according to the present invention further include an attachment element. The attachment element is anything to assist in the securement of the safety marker indicator device to an architectural structure such as by an interference fit or snap fit or adhesive fit. An attachment element, for example, may be hardware including screws or nails, adhesive including liquid or tape adhesive, Velcro®, clips or snaps or expanding anchors. The attachment element assists in permanently securing the safety marker indicator device to the architectural structure; although it is contemplated the safety marker indicator device may be portable.

The base element of the present invention is made of any material that can be molded or extruded, for example metal such as aluminum or powdered metals, composite lumber, and polymers, thermoset or thermoplastic resins. Polymers include plastics such as thermoplastic, thermoset plastic, polyurethane, polyethylene, polypropylene and engineering plastic, for example, synthetic polymers including nylon. The materials may further be compounded with a glass fiber or powdered metal to maintain rigidity such that the device does not warp or twist during manufacturing or installation. The base element may also be manufactured from the materials of the light emission element.

The light emission element is manufactured from a photoluminescent material capable of producing a sustained visible glow including in darkness such as at a minimum of one hour or longer. The photoluminescent material includes a fluorescent quality, for example, strontium oxide, strontium aluminate, strontium silicate with magnesium or metal sulfides such as calcium sulfide, strontium sulfide, zinc sulfide, and cadmium sulfide. The light emission element may further be a metal or polymer. More specifically, the light emission element is located on the outside surface of the base element. The light emission element stores energy, for example, as by absorbing photons and releasing the energy as light over a duration of time.

The material used for the safety marker indicator device is easily cut, for example on a table saw or miter saw or even scissors. It is further contemplated that the material may be cured by a radiation source such as ultraviolet (UV) light or contain a UV additive in the material. Additionally, the material may be impact modified to improve the material properties such as wear, non-slip, and weatherability. The material may also be compounded with a flame retardant additive to meet certain fire codes and regulations.

Additional embodiments may also include a communication element. A communication element is anything that conveys information, for example, text, advertisement, or logo. The communication element may be positioned on the base element and manufactured using pad printing, embossing, engraving, in-mold decorating, or two-shot molding to name a few.

In another embodiment of the present invention, the base element of the safety marker indicator device includes a substrate element and a light emission element. The advantages of a substrate element are that it may optimize the illumination of the light emission element. In a preferred embodiment, the substrate element is white although any color is contemplated to achieve the advantages discussed herein.

The present invention is manufactured by extrusion, co-extrusion, injection molding, or two-shot molding although any manufacturing process is contemplated. Extrusion is a process for manufacturing wherein material is pushed or drawn through a die in the desired shape of a fixed cross-sectional profile of the device. The device is cooled and solidified as it is pulled through the die. In one embodiment the base element is extruded.

Co-extrusion is the manufacturing process of extruding two or more materials through a single die with two or more orifices arranged so that the two or more materials, which may further be of different color, merge and weld together. Each material is fed to the die from a separate extruder, but the orifices may be arranged so that each extruder supplies two or more plies. Each ply may be of the same material, or each ply may be of different materials such as one ply of a white polymer material for the substrate element and the other ply of a strontium silicate with magnesium for the photoluminescent light emission element that is co-extruded upon the polymer material. In one embodiment according to the present invention, the substrate element and the light emission element are co-extruded using two plies to achieve the safety marker indicator device.

Injection molding is a manufacturing process for making components by injecting materials at high pressure into a mold shaped as the inverse of the desired shape of the component. In one embodiment, the base element is injection molded.

Two-shot injection molding allows the production of a device from two different materials, which may further be of different color, at the same time during one machine cycle. The two different materials may be joined to form the device, for example, through a heat and pressure process or bonded through mechanical interference. In one embodiment, the substrate element and light emission element are manufactured with a two-shot injection molding process.

An object of the present invention is to provide an improved safety marker indicator device that complies with all current and future contemplated industry standards and specifications, including Property Services Agency (PSA), International Building Code (IBC), National Fire Protection Association (NFPA), International Code Compliance (ICC), American National Standards Institute (ANSI), International Residential Code (IRC), and American with Disabilities Act (ADA).

Yet another object of the present invention is to reduce risks that may occur when people attempt to navigate in poorly lit environments. The present invention provides devices that function as a safety egress or ingress pathway to quickly evacuate people in the case of an emergency.

Another object of the present invention is to provide a safety marker indicator device manufactured by extrusion, co-extrusion, injection molding, or two-shot injection molding.

Yet another object of the present invention is to provide a safety marker indicator device that requires little to no maintenance.

Yet another object of the present invention is to provide a light emission element that is integrated with the base element such that it does not lift or peel away.

Yet another object of the present invention is to provide a manufacturing process for a device comprising compatible materials as well as a device comprising non-compatible materials.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A is a perspective view of a safety marker indicator device according to one embodiment of the present invention;

FIG. 1B is a perspective view of a safety marker indicator device according to another embodiment of the present invention;

FIG. 1C is a perspective view of a safety marker indicator device according to another embodiment of the present invention;

FIG. 1D is a perspective view of a safety marker indicator device according to another embodiment of the present invention;

FIG. 1E is a perspective view of a safety marker indicator device according to another embodiment of the present invention;

FIG. 2A illustrates the safety marker indicator device of FIG. 1A as a door marker indicator device on a knob door handle;

FIG. 2B illustrates the safety marker indicator device of FIG. 1B as a door marker indicator device on a lever door handle;

FIG. 2C illustrates the safety marker indicator device of FIG. 1C as a door marker indicator device on a slider door handle;

FIG. 2D illustrates the safety marker indicator device of FIG. 1D as a door marker indicator device on a push-bar door handle;

FIG. 2E illustrates a side view of another embodiment of the safety marker indicator device of FIG. 1D as a door marker indicator device on a push-bar door handle:

FIG. 2F illustrates the safety marker indicator device of FIG. 1E as a door marker indicator device on a lever door handle; and

FIG. 2G illustrates the safety marker indicator device of FIG. 1E as a door marker indicator device on a slider door handle.

### DESCRIPTION OF PREFERRED EMBODIMENTS

Preferred embodiments of a safety marker indicator device according to the present invention are generally shown by referring to the accompanying drawings.

The present invention is discussed herein as a door marker indicator device with respect to architectural structures that are doors or door components, and more specifically to door handles, although any architectural structure is contemplated.

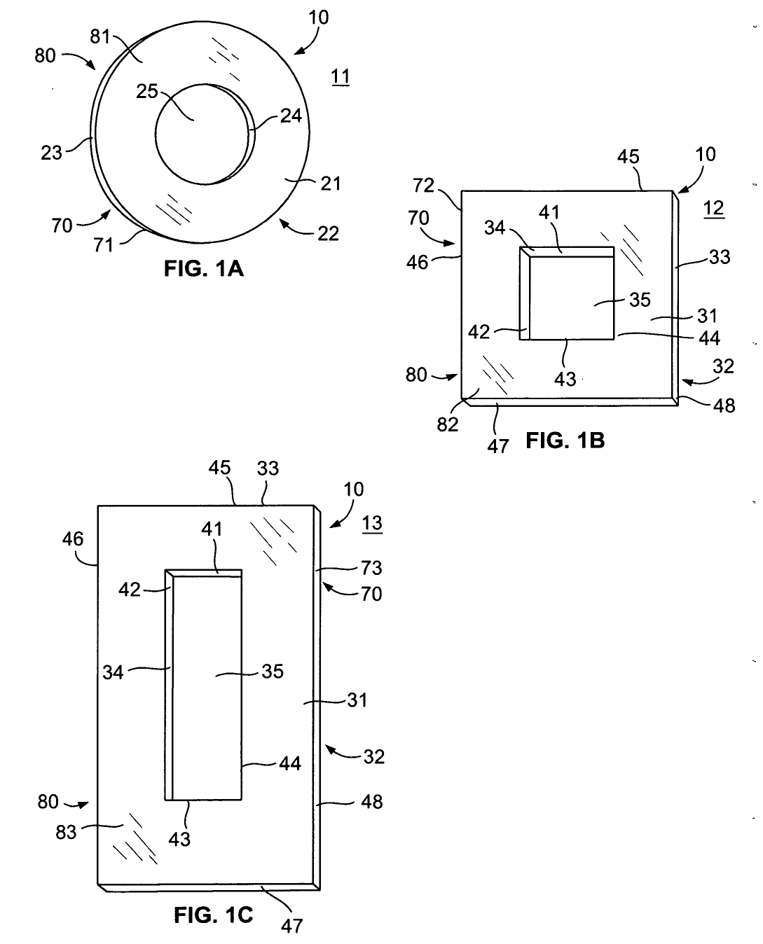

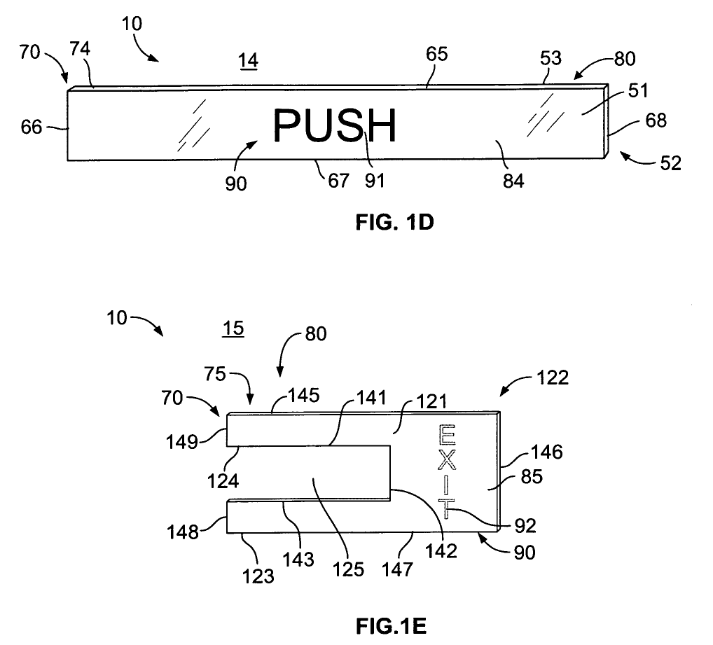

Different embodiments of the present invention are shown in FIG. 1A, FIG. 1B, FIG. 1C, FIG. 1D, and FIG. 1E. The safety marker indicator device 10 shown in FIG. 1A includes a circular base element 11 with a front surface 21, back surface 22, an outer edge 23, and inner edge 24, which forms a center aperture 25. The embodiment of FIG. 1A further includes an attachment element 70 and light emission element 80. The attachment element 70 is adhesive tape 71 on the back surface 22 of the base element 11 and the light emission element 80 is strontium silicate material 81 on the front surface 21 of the base element 11. It is contemplated that the strontium silicate material 81 may further include magnesium.

Other embodiments according to the present invention include a safety marker indicator device 10 with a four-sided base element; shown in FIG. 1B as a square base element 12 and shown in FIG. 1C as a rectangular base element 13.

As shown in FIG. 1B and FIG. 1C, the four-sided base element 12, 13 includes a front surface 31, back surface 32, an outer edge 33 and inner edge 34. The inner edge 34 comprises a first border 41, second border 42, third border 43, and fourth border 44 that forms a center aperture 35. The outer edge 33 comprises a first boundary 45, second boundary 46, third boundary 47 and fourth boundary 48.

As shown in FIG. 1B, attachment element 70 is a liquid adhesive 72 on the back surface 32 and the light emission element 80 is a zinc sulfide material 82 on the front surface 31.

As shown in FIG. 1C, attachment element 70 is Velcro® 73 on the back surface 32 and light emission element 80 is a strontium sulfide material 83 on the front surface 31.

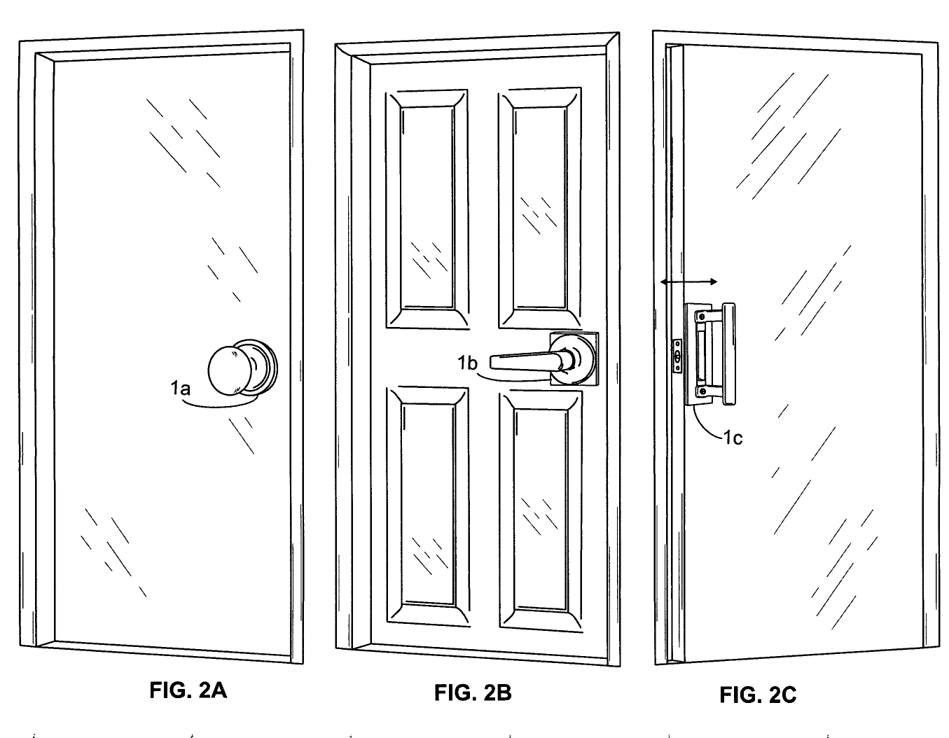

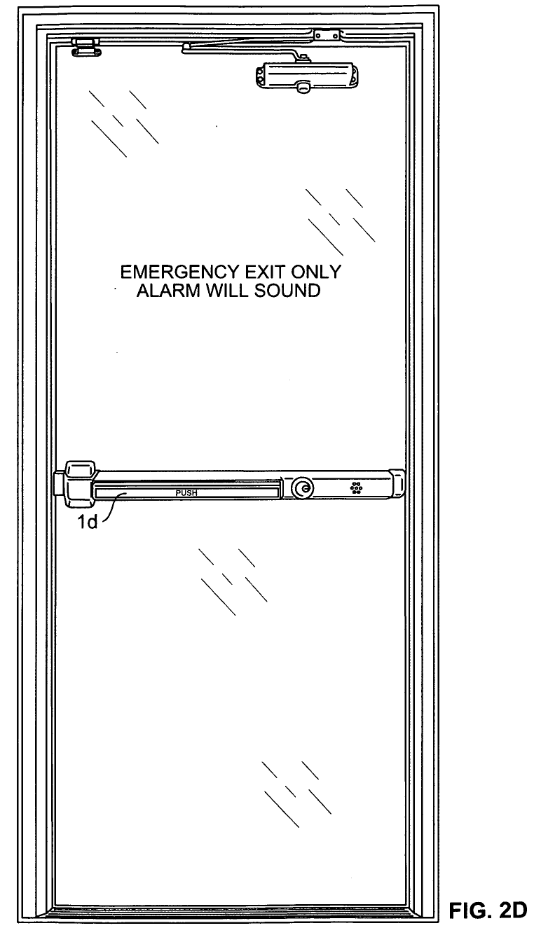

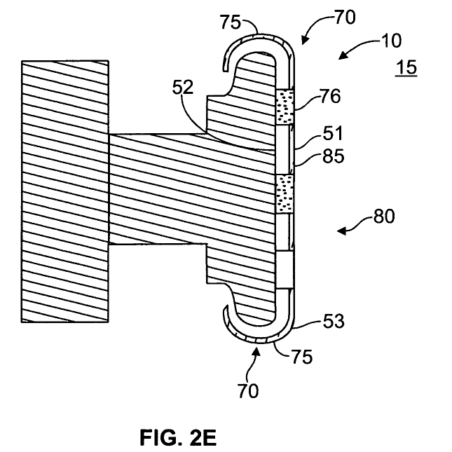

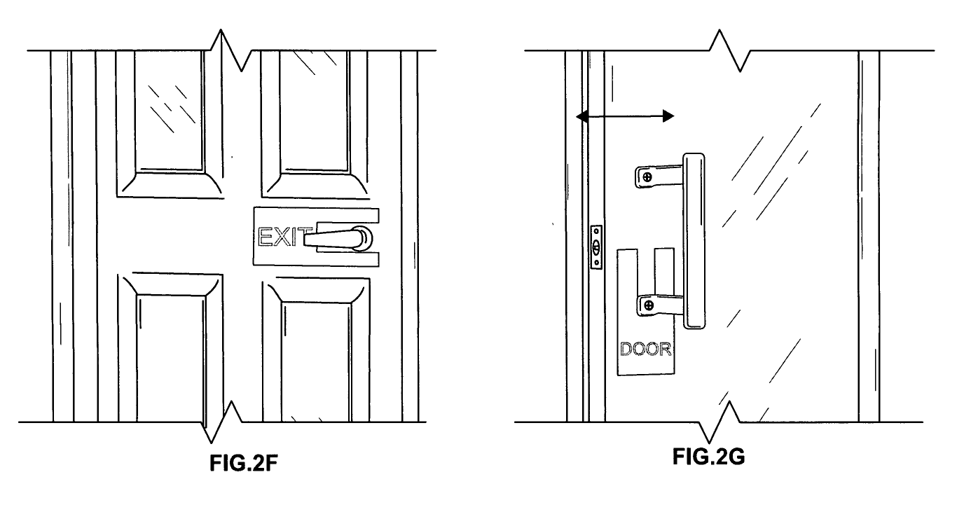

As shown in FIG. 1D, the safety marker indicator device 10 is a pad base element 14 that includes an outer edge 53 forming a front surface 51 and a back surface 52. Outer edge 53 includes a first boundary 65, second boundary 66, third boundary 67 and fourth boundary 68. The front surface 51 includes a light emission element 80 that is strontium oxide material 84 and the back surface 52 includes an attachment element 70, here adhesive tape 74. In this embodiment, the base element 14 further includes a communication element 90 shown here as text 91 that is pad printed onto the front surface 51. It is also contemplated that the safety marker indicator device 10 may include additional attachment elements 70 in the form of clips for a snap-on fit to a push-bar door handle, as shown more specifically in FIG. 2E. In another embodiment, the safety marker indicator device 10 may include anchors on the back surface 52 that secure to apertures of a push-bar door handle. Upon engagement of the anchors to the apertures, the anchors expand to secure the safety marker indicator device 10 to the push-bar door handle. As mentioned above, it is also contemplated that the entire push-bar door handle itself may be manufactured from a photoluminescent material.

As shown in FIG. 1E, the safety marker indicator device 10 is a partial rectangular shape. The safety marker indicator device includes an a U-shaped base element 15 with a front surface 121, back surface 122, an outer edge 123, and inner edge 124. The inner edge 124 comprises a first border 141, second border 142, and third border 143, that forms a center aperture 125. The outer edge 123 comprises a first boundary 145, second boundary 146, third boundary 147, fourth boundary 148 and fifth boundary 149. The embodiment of FIG. 1E further includes an attachment element 70 and light emission element 80. The attachment element 70 is adhesive 75 on the back surface 122 of the base element 15 and the light emission element 80 is a combination of a strontium silicate and magnesium material 85 on the front surface 121 of the base element 15. The base element 15 further includes a communication element 90 shown here as text 92, more specifically as “exit”, but any text is contemplated such as “door” as shown in FIG. 2G. The embodiment of FIG. 1E allows for various attachment configurations, i.e., vertical or horizontal, as shown in FIG. 2F and FIG. 2G.

It is contemplated that the embodiments of the safety marker indicator device described in FIG. 1A, FIG. 1B, FIG. 1C, FIG. 1D and FIG. 1E may have a base element that includes a substrate element and a light emission element. The substrate element is positioned behind the light emission element such that the substrate element is the back surface of the base element and the light emission element is the front surface of the base element. With these embodiments that further include an attachment element, the attachment element is positioned on the substrate element—or back surface of the base element.

FIG. 2A illustrates the safety marker indicator device of FIG. 1A on a knob door handle. FIG. 2B illustrates the safety marker indicator device of FIG. 1B on a lever door handle. FIG. 2C illustrates the safety marker indicator device of FIG. 1C on a slider door handle and FIG. 2D illustrates the safety marker indicator device of FIG. 1D on a push-bar door handle.

FIG. 2E illustrates a side view of another embodiment of the safety marker indicator device 10 of FIG. 1D as a door marker indicator device on a push-bar door handle. As shown in FIG. 2E, the safety marker indicator device 10 is a pad base element 15 that includes an outer edge 53 forming a front surface 51 and a back surface 52. Outer edge 53 includes attachment elements 70 in the form of clips 75 for a snap-on fit to a push-bar door handle. The back surface 52 may further include attachment element 70 as adhesive tape 76. The front surface 51 includes a light emission element 80 that is strontium silicate with magnesium material 85. It is also contemplated that this embodiment may further include a communication element 90 on the front surface 51 of the base element 15.

FIG. 2F illustrates the safety marker indicator device of FIG. 1E as a door marker indicator device on a lever door handle and FIG. 2G illustrates the safety marker indicator device of FIG. 1E as a door marker indicator device on a slider door handle. Various attachment configurations are contemplated beyond those as illustrated in FIG. 2F and 2G. For example, the safety marker indicator device may be rotated around either a vertical axis or horizontal axis (e.g., any border element or boundary element).

It will be understood that the embodiments of the present invention which have been described are illustrative of some of the applications of the principles of the present invention. Numerous modifications may be made by those skilled in the art without departing from the true spirit and scope of the invention.

What is claimed is:

1. A safety marker indicator device comprising:
a base element including a front surface and a back surface, said base element further including an outer edge and an inner edge, wherein said inner edge forms a center aperture;
an attachment element on said back surface of said base element for securing the device; and
a photoluminescent light emission element on said front surface.

2. The safety marker indicator device of claim 1, further comprising a communication element on said front surface of said base element.

3. The safety marker indicator device of claim 1, wherein the safety marker indicator device is manufactured by extrusion.

4. The safety marker indicator device of claim 1, wherein the safety market indicator device is manufactured by injection molding.

5. The safety marker indicator device of claim 1, wherein said photoluminescent light emission element is a strontium silicate material.

6. The safety marker indicator device of claim 5, wherein said strontium silicate material further includes a magnesium material.

7. The safety marker indicator device of claim 1, wherein said photoluminescent light emission element is a strontium oxide material.

8. A door marker indicator device comprising:
a base element including a front surface, back surface, and outer edge comprising a first boundary, second boundary, third boundary and fourth boundary;
an attachment element on said back surface of said base element for securing the device; and
a photoluminescent light emission element on said front surface of said base element.

9. The door marker indicator device of claim 8, further comprising a communication element on said front surface of said base element.

10. The door marker indicator device of claim 8, wherein the door marker indicator device is manufactured by extrusion.

11. The door marker indicator device of claim 8, wherein the door marker indicator device is manufactured by injection molding.

12. The door marker indicator device of claim 8, wherein said attachment element is adhesive.

13. The door marker indicator device of claim 8, wherein said photoluminescent light emission element is a strontium silicate material.

14. The door marker indicator device of claim 13, wherein said strontium silicate material further includes a magnesium material.

15. The door marker indicator device of claim 8, wherein said photoluminescent light emission element is a strontium oxide material.
